(19) United States
(12) Patent Application Publication
(10) Pub. No.: US 2018/0049571 A1
(43) Pub. Date: Feb. 22, 2018

(54) DECANTER ASSEMBLY

(71) Applicant: Dongguan Kinyet Metal Products Co., Ltd., Dongguan (CN)

(72) Inventor: Yungchang Lu, Dongguan (CN)

(73) Assignee: Dongguan Kinyet Metal Products Co., Ltd., Dongguan (CN)

(21) Appl. No.: 15/239,240

(22) Filed: Aug. 17, 2016

(51) Int. Cl. A47G 23/02; B01F 13/08; B01F 3/04

(52) U.S. Cl. CPC A47G 23/0241; B01F 13/08; B01F 2215/0072; B01F 3/04531; B01F 3/04794

(57) ABSTRACT

The present invention relates to a decanter assembly, includes a bottle structure, a seat and a motor sub-assembly; the bottle structure is located on the seat; the seat includes a base and a shield located on the base, the shield forms an accommodating cavity for containing the bottle structure; the bottle structure is contained in the accommodating cavity, a magnet is positioned at the bottom of the bottle structure; the motor sub-assembly is set in the base under the bottle structure, the motor sub-assembly drives the magnet to rotate, thus stirring the wine in the bottle structure and sobering it up. The magnet, driven by the motor, is rotated to stir wine in the bottle structure at a constant rate, at the same time the light emitted by the LED lamp directly irradiates the wine in the bottle, combining with the shock of the low frequency music, all of these have the function of sobering up quickly, the music and the light can adjust atmosphere and produce good visual effects and audio effects, thus person can enjoy the sobering process from vision, hearing and taste, it greatly improves your life style.

### FIELD OF THE INVENTION

The invention relates to decanters technology field, more particularly relates to a decanter assembly.

### BACKGROUND OF THE INVENTION

The Chinese invention with Authorization Announcement No. CN204561894U, named red wine fast decanter with luminous music, includes the body, the body includes luminous music fixed part and a wine pipe, the luminous music fixed part internally mounts a MP3 player, the surface of the luminous music fixed part is equipped with a USB jack and an annular LED lamp, the annular LED lamp is established in the junction of the luminous music fixed part and the wine pipe. The utility model discloses a decanter having music broadcast and light scintillation function. People can enjoy music and light scintillation effect when sobering up, thus adjusting the atmosphere, drinking and listening the song to neglect neither.

The above ware belongs to static device with not well effect of sobering and single function.

Accordingly, it urgently needs to provide a decanter assembly to overcome the deficiencies of the prior art.

### SUMMARY OF THE INVENTION

To overcome the above shortcomings, the present invention provides a decanter assembly with good effect of sobering and multi-function.

The technologies in the present invention are as follows:

A decanter assembly, includes a bottle structure, a seat and a motor sub-assembly; the bottle structure is located on the seat; the seat includes a base and a shield located on the base, the shield forms an accommodating cavity for containing the bottle structure; the bottle structure is contained in the accommodating cavity, a magnet is positioned at the bottom of the bottle structure; the motor sub-assembly is set in the base under the bottle structure, the motor sub-assembly drives the magnet to rotate, thus stirring the wine in the bottle structure and sobering it up.

The bottle structure has a bottle and a bottle seat set at the bottom of the bottle, a rotating cavity is arranged in the bottle seat, the magnet is contained in the rotating cavity.

Preferably, a silicone sealing gasket is positioned at the bottom of the bottle.

Preferably, a groove matching with the bottle seat is positioned at the bottom of the accommodating cavity.

The base includes an above shell, a lower shell and a cavity between them; the motor sub-assembly includes a motor seat, a motor and a magnet; the motor seat is located on the lower shell, the motor is contained in the motor seat, the magnet is located on the motor; the cavity is provided with a main circuit board electrically connected with the motor.

The decanter assembly also includes a LED lamp assembly contained in the cavity; the LED lamp assembly is located on the motor seat, including a LED lamp board, LED lamps and a lampshade; the LED lamp board is fixed on the motor seat, the LED lamps are uniformly distributed on the LED lamp board; the lampshade is transparent and cover the LED lamp board; the LED lamp is electrically connected with the main circuit board, the light emitted by the LED lamp is three primary colors RGB.

A first through hole is positioned on the above shell, a second through hole is positioned in the groove, the motor sub-assembly and the LED lamp assembly are located at the first through hole, thus the LED lamp can directly irradiate the bottle structure put on the groove.

Furtherly, the base is provided with an audio input, the shield is provided with circular iron nets, the circular iron nets are provided with horns.

Preferably, a touch assembly is positioned on the base, the touch assembly includes a touch screen, a touch circuit board, display, a display screen, a display circuit board.

Preferably, the base is provided with pads.

Preferably, the base is provided with DC power input.

The decanter assembly in the present invention has the follow advantages: the magnet, driven by the motor, is rotated to stir the wine in the bottle structure at a constant rate, at the same time the light emitted by the LED lamp directly irradiates the wine in the bottle, combining with the shock of the low frequency music, all of these have the function of sobering up quickly, the music and the light can adjust atmosphere and produce good visual effects and audio effects, thus person can enjoy the sobering process from vision, hearing and taste, it greatly improves your life style.

### BRIEF DESCRIPTION OF THE DRAWINGS

FIG. 1 shows the isometric view of the seat in the decanter assembly in present invention.

FIG. 2 shows the exploded view of the seat in FIG. 1.

FIG. 3 shows the top view of the seat in the decanter assembly of FIG. 1.

FIG. 4 shows the across-sectional views of the seat along the A-A line in FIG. 3.

FIG. 5 shows the isometric view of the bottle structure in the decanter assembly in present invention.

### DETAILED DESCRIPTION OF ILLUSTRATED EMBODIMENTS

The follows will further descript the present invention with the embodiments, which are the preferable embodiments in the present invention.

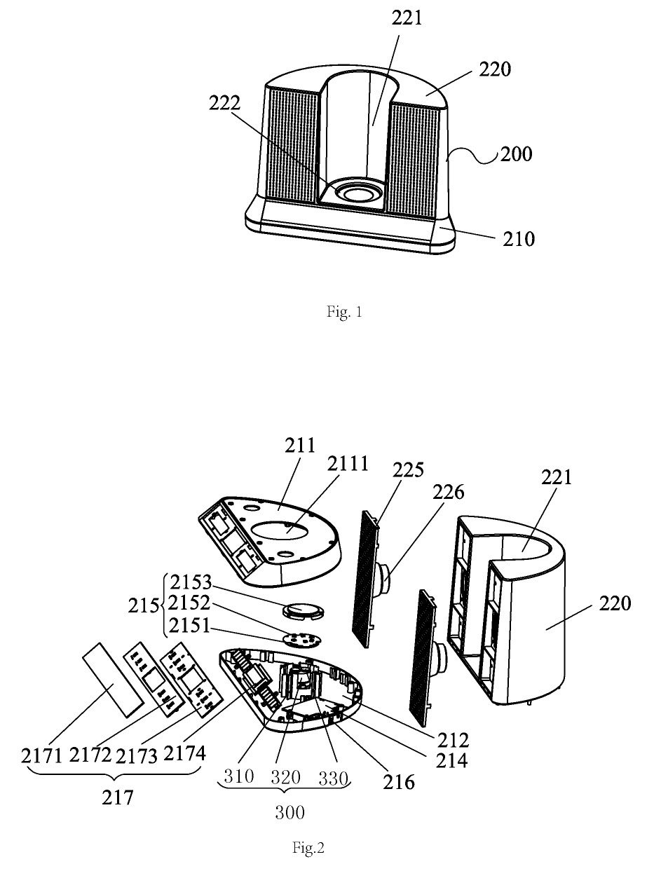

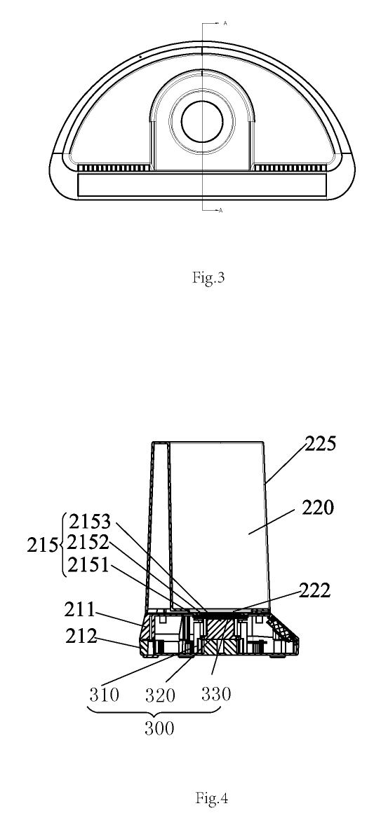

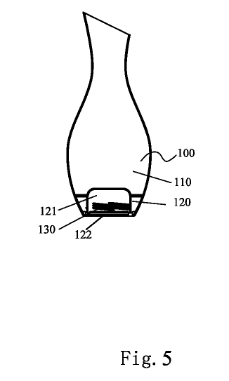

Referring FIG. 1 and FIG. 5, a decanter assembly, includes a bottle structure 100, the seat 200 and a motor sub-assembly 300.

The bottle structure 100 is located on the seat 200. The bottle structure 100 has a bottle 110, a bottle seat 120 set on the bottom of the bottle and a magnet 130. A rotating cavity 121is positioned in the bottle seat 120, the magnet 130 is contained in the rotating cavity 121. Preferably, a silicone sealing gasket 122 is positioned at the bottom of the bottle 120.

The seat 200 includes a base 210 and a shield 220 set on the base. The shield 220 forms an accommodating cavity 221 for containing the bottle structure 100. When sobering up, the bottle structure 100 is contained in the accommodating cavity 221. A motor sub-assembly 230 is set in the base 210 under the bottle structure 100. The magnet 130, driven by the motor sub-assembly 300, is rotated to stir the wine in the bottle structure 100. The wine fully contacts with oxygen in the air and is oxidized for sobering.

Preferably, a groove 222 matching with the bottle seat 120 is provided at the bottom of the accommodating cavity 221.

The base 210 includes an above shell 211, a lower shell 212 and a cavity between them, the above shell 211 and the lower shell 212 are linked together by screws, rivets and fasteners etc.

The motor sub-assembly 300 contained in the base 210 includes a motor seat 310, a motor 320 and a magnet 330; the motor seat 310 is located on the lower shell 212, the motor 320 is contained in the motor seat 310, the motor 320 and the motor seat 310 fixes together by the pillar holes and pillars set on them. The magnet 330 is located on the motor 320; in the cavity is provided with a main circuit board 214 electrically connected with the motor 320.

The descanter assembly also includes a LED lamp assembly 215 contained in the cavity. The LED lamp assembly 215 is located on the motor seat 310, including a LED lamp board 2151, LED lamps 2152 and a lampshade 2153; the LED lamp board 2151is fixed on the motor seat 310, the LED lamps 2152 are uniformly distributed on the LED lamp board 2151; the lampshade 2153 is transparent and cover the LED lamp board 2151; the LED lamp 2152 is electrically connected with the main circuit board 214, the light emitted by the LED lamp 2152 is three primary colors RGB. When the three primary colors RGB irradiate the wine, it has the function of sobering.

A first through hole 2111 is provided on the above shell 211, a second through hole is provided in the groove 222, the motor sub-assembly 300 and the LED lamp assembly 215 are located at the first through hole 2111, thus the LED lamp 2152 can directly irradiate the bottle structure 100 put on the groove 222.

Furtherly, an audio input 216 is provided on the base 210, circular iron nets 224 are provided on the shield 220, horns 225 is provided on the circular iron nets 224. The audio input 216 is used for playing low frequency music, with the function of low frequency music; the process of sobering up is faster.

Preferably, a touch assembly 217 is provide on the base 210, the touch assembly 217 includes a touch screen 2171, a touch circuit board 2172, a display screen 2173, a display circuit board 2174 etc. The touch screen 2171 is used for selecting the relative working model, for example stir model, stir and low frequency music model, stir and LED lamps model, stir, LED Lamp and low frequency music model etc., it is convenient for using.

Preferably, pads are provided at the bottom of the base 210. The pads have the function of shockproof.

Preferably, bluetooth is provided on the base 210.

Preferably, A DC power input is provided on the base 210. The DC power input can connect with portable battery, it is convenient for using.

While the specification has described in detail certain exemplary embodiments, it will be appreciated that those skilled in the art, upon attaining an understanding of the foregoing, may readily conceive of alterations to, variations of, and equivalents to these embodiments.

What is claimed:

1. A decanter assembly, wherein includes a bottle structure, a seat and a motor sub-assembly; said bottle structure is located on the seat; said seat includes a base and a shield located on the base, said shield forms an accommodating cavity for containing the bottle structure; said bottle structure is contained in said accommodating cavity, a magnet is provided at the bottom of said bottle structure;
said motor sub-assembly is set in said base under said bottle structure, said motor sub-assembly drives said magnet to rotate, thus stirring wine in said bottle structure and sobering it up.

2. A decanter assembly according to claim 1, wherein said bottle structure has a bottle and a bottle seat set at the bottom of said bottle, a rotating cavity is positioned in said bottle seat, said magnet is contained in said rotating cavity.

3. A decanter assembly according to claim 2, wherein a silicone sealing gasket is positioned at the bottom of the bottle.

4. A decanter assembly according to claim 2, wherein a groove matching with the bottle seat is positioned at the bottom of the accommodating cavity.

5. A decanter assembly according to claim 1, wherein said base includes an above shell, a lower shell and a cavity between them; said motor sub-assembly includes a motor seat, a motor and a magnet; said motor seat is located on said lower shell, said motor is contained in said motor seat, said magnet is located on said motor;
said cavity is provided with a main circuit board electrically connected with the motor.

6. A decanter assembly according to claim 5, wherein said decanter assembly also includes a LED lamp assembly contained in the cavity; said LED lamp assembly is located on said motor seat, said LED lamp assembly includes a LED lamp board, LED lamps and a lampshade; said LED lamp board is fixed on said motor seat, said LED lamps are uniformly distributed on said LED lamp board; said lampshade is transparent and cover said LED lamp board; said LED lamp is electrically connected with said main circuit board, light emitted by said LED lamp is three primary colors RGB.

7. A decanter assembly according to claim 6, wherein a first through hole is positioned on said above shell, a second through hole is positioned in said groove, said motor sub-assembly and said LED lamp assembly are located at said first through hole, thus said LED lamp can directly irradiate said bottle structure put on said groove.

8. A decanter assembly according to claim 1, wherein said base is provided with an audio input, said shield provided with circular iron nets, said circular iron nets are provided with horns.

9. A decanter assembly according to claim 1, wherein said base is provided with a touch assembly, said touch assembly includes a touch screen, a touch circuit board, a display, a display screen, a display circuit board.

10. A decanter assembly according to claim 1, wherein in said base is provided with pads; said base is provided with pads DC power input.
